(19) United States
(12) Patent Application Publication
(10) Pub. No.: US 2025/0008473 A1
(43) Pub. Date: Jan. 2, 2025

(54) METHODS AND APPARATUSES FOR SIDELINK POSITIONING

(71) Applicant: Lenovo (Beijing) Limited, Beijing (CN)

(72) Inventors: Jie Hu, Beijing (CN); Jing Han, Beijing (CN); Haiming Wang, Beijing (CN); Lianhai Wu, Beijing (CN); Ran Yue, Beijing (CN)

(73) Assignee: Lenovo (Beijing) Limited, Beijing (CN)

(21) Appl. No.: 18/702,957

(22) PCT Filed: Oct. 22, 2021
(86) PCT No.: PCT/CN2021/125770

§ 371 Date: Apr. 19, 2024

(51) Int. Cl. H04W 64/00; H04L 5/00; H04W 8/00; H04W 76/20; H04W 92/18

(52) U.S. Cl. CPC H04W 64/00; H04L 5/0051; H04W 8/005; H04W 76/20; H04W 92/18

(57) ABSTRACT

Embodiments of the present disclosure relate to methods and apparatuses for sidelink (SL) positioning. According to an embodiment of the present disclosure, a first user equipment (UE) can include: a processor configured to perform an SL positioning procedure with a second UE; a transmitter coupled to the processor and configured to transmit an abort message to abort the SL positioning procedure to the second UE; and a receiver coupled to the processor. The processor is further configured to abort the SL positioning procedure in response to transmitting the abort message.

### TECHNICAL FIELD

Embodiments of the present application generally relate to wireless communication technology, and especially to methods and apparatuses for sidelink (SL) positioning.

### BACKGROUND

SL positioning refers to transmitting positioning reference signal (PRS) over SL, which can operate independently of network or radio access technology (RAT) coverage and provide a new positioning method that fits new network use cases.

Service requirements for SL positioning have been defined in corresponding specification, e.g., the requirements for Vehicle-to-Everything (V2X) and public safety use case can also apply to SL positioning. Based on the specified requirements, solutions for SL positioning need be studied to support “both in coverage,” “partial coverage” and “both out of coverage” scenarios. Moreover, coordination procedures between user equipments (UEs) and between UE and network, and corresponding UE designs need be considered from RAN2's perspective for SL positioning designs.

### SUMMARY OF THE APPLICATION

Embodiments of the present application at least provide technical solutions for SL positioning.

According to some embodiments of the present application, a first UE may include: a processor configured to perform an SL positioning procedure with a second UE; a transmitter coupled to the processor and configured to transmit an abort message to abort the SL positioning procedure to the second UE; and a receiver coupled to the processor. The processor is further configured to abort the SL positioning procedure in response to transmitting the abort message.

In some embodiments of the present application, the second UE helps the first UE to acquire its position, and the processor is further configured to: in the case that an SL positioning method and at least one of an RAT-dependent positioning method or RAT-independent positioning method are available for the first UE, determine to use the SL positioning method based on at least one of an accuracy requirement or a latency requirement of a target service; in the case that only the SL positioning method is available for the first UE, determine to use the SL positioning method in response to at least one of the followings: SL PRS information for the first UE satisfies the accuracy requirement of the target service; or a number of anchor UEs discovered by the first UE is larger than or equal to a minimum number of anchor UEs for the accuracy requirement of the target service; and initiate the SL positioning procedure with the second UE in response to determining to use the SL positioning method.

In some embodiments of the present application, the second UE helps the first UE to acquire its position, and the receiver is configured to receive positioning assistance data which includes SL PRS information, and the processor is further configured to initiate the SL positioning procedure with the second UE in response to receiving the positioning assistance data.

In some embodiments of the present application, the abort message includes an identification (ID) associated with the SL positioning procedure.

In some embodiments of the present application, the abort message is a radio resource control (RRC) message, and the identification is a layer-2 ID associated with the SL positioning procedure.

In some embodiments of the present application, the abort message is an upper layer message.

In some embodiments of the present application, the receiver is configured to receive an abort message including the identification associated with the SL positioning procedure from a network.

In some embodiments of the present application, the second UE helps the first UE to acquire its position, and the transmitter is configured to transmit the abort message to the second UE in response to at least one of the following conditions: a target service is cancelled by the first UE; the first UE receives an abort message associated with the SL positioning procedure from a location management function (LMF); an SL positioning method cannot guarantee an accuracy requirement of a target service of the first UE; or the first UE decides to abort the SL positioning procedure by the first UE's implementation.

In some embodiments of the present application, the SL positioning method cannot guarantee the accuracy requirement of the target service of the first UE when at least one of the following conditions occurs: a new positioning method different from the SL positioning method is available for the first UE and the first UE determines to change to use the new positioning method; a number of available anchor UEs for the first UE is lower than a minimum number of anchor UEs for the accuracy requirement of the target service; or new PRS information different from current PRS information is acquired by the first UE.

In some embodiments of the present application, the first UE helps the second UE to acquire its position, and the transmitter is configured to transmit the abort message to the second UE in response to at least one of the following conditions: a positioning capability of the first UE to support the SL positioning procedure changes; the first UE receives an abort message associated with the SL positioning procedure from an LMF; or the first UE decides to abort the SL positioning procedure by the first UE's implementation.

In some embodiments of the present application, the second UE helps the first UE to acquire its position, and the receiver is configured to receive new PRS information different from current PRS information in or along with an abort message associated with the SL positioning procedure from a network. The new PRS information includes at least one of: new anchor UE information different from current anchor UE information or an indication to trigger an SL anchor UE selection or reselection procedure; a PRS configuration or sounding reference signal (SRS) configuration related to RAT-dependent positioning; or a new SL PRS configuration related to SL positioning different from a current SL PRS configuration.

In some embodiments of the present application, the receiver is configured to receive positioning assistance data, and the new PRS information and the abort message associated with the SL positioning procedure are included in the positioning assistance data.

In some embodiments of the present application, the first UE helps the second UE to acquire its position, and the receiver is configured to receive new PRS information different from current PRS information in or along with an abort message associated with the SL positioning procedure from a network. The new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration. The transmitter is configured to transmit the received new PRS information in or along with the abort message that is transmitted to the second UE.

In some embodiments of the present application, the second UE helps the first UE to acquire its position, and the transmitter is further configured to transmit a PRS information request to a network to acquire new PRS information different from current PRS information before transmitting the abort message. The receiver is configured to receive the new PRS information before the transmitter transmits the abort message, wherein the new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, the first UE helps the second UE to acquire its position, and the transmitter is further configured to transmit an indication to a network to indicate that the SL positioning procedure will be aborted before transmitting the abort message.

In some embodiments of the present application, the receiver is configured to receive new PRS information different from current PRS information from the network, and the transmitter is configured to transmit the received new PRS information in or along with the abort message to the second UE. The new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, to abort the SL positioning procedure, the processor is configured to abort at least one of: a positioning capability transfer procedure between the first UE and the second UE; an SL PRS configuration procedure between the first UE and the second UE; an SL PRS transmission procedure between the first UE and the second UE; or a measurement reporting procedure between the first UE and the second UE.

According to some embodiments of the present application, a second UE may include: a processor configured to perform an SL positioning procedure with a first UE; a transmitter coupled to the processor; and a receiver coupled to the processor and configured to receive an abort message to abort the SL positioning procedure from the first UE. The processor is further configured to abort the SL positioning procedure in response to receiving the abort message.

In some embodiments of the present application, to abort the SL positioning procedure, the processor is configured to abort at least one of: a positioning capability transfer procedure between the first UE and the second UE; an SL PRS configuration procedure between the first UE and the second UE; an SL PRS transmission procedure between the first UE and the second UE; or a measurement reporting procedure between the first UE and the second UE.

In some embodiments of the present application, the first UE helps the second UE to acquire its position, and the processor is further configured to: in the case that an SL positioning method and at least one of an RAT-dependent positioning method or RAT-independent positioning method are available for the second UE, determine to use the SL positioning method based on at least one of an accuracy requirement or a latency requirement of a target service; in the case that only the SL positioning method is available for the second UE, determine to use the SL positioning method in response to at least one of the followings: SL PRS information for the second UE satisfies the accuracy requirement of the target service; or a number of anchor UEs discovered by the second UE is larger than or equal to a minimum number of anchor UEs for the accuracy requirement of the target service; and initiate the SL positioning procedure with the first UE in response to determining to use the SL positioning method.

In some embodiments of the present application, the first UE helps the second UE to acquire its position, the receiver is configured to receive positioning assistance data which includes SL PRS information, and the processor is further configured to initiate the SL positioning procedure with the first UE in response to receiving the positioning assistance data.

In some embodiments of the present application, the abort message includes an identification associated with the SL positioning procedure.

In some embodiments of the present application, the abort message is an RRC message, and the identification is a layer-2 ID associated with the SL positioning procedure.

In some embodiments of the present application, the abort message is an upper layer message.

In some embodiments of the present application, the first UE helps the second UE to acquire its position, and the receiver is further configured to receive new PRS information different from current PRS information from a network. The new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, the first UE helps the second UE to acquire its position, and the receiver is further configured to receive new PRS information different from current PRS information in or along with the abort message from the first UE. The new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

According to some embodiments of the present application, a method performed by a first UE may include: performing an SL positioning procedure with a second UE; transmitting an abort message to abort the SL positioning procedure to the second UE; and aborting the SL positioning procedure in response to transmitting the abort message.

In some embodiments of the present application, the second UE helps the first UE to acquire its position, and the method further includes: in the case that an SL positioning method and at least one of an RAT-dependent positioning method or RAT-independent positioning method are available for the first UE, determining to use the SL positioning method based on at least one of an accuracy requirement or a latency requirement of a target service; in the case that only the SL positioning method is available for the first UE, determining to use the SL positioning method in response to at least one of the followings: SL PRS information for the first UE satisfies the accuracy requirement of the target service; or a number of anchor UEs discovered by the first UE is larger than or equal to a minimum number of anchor UEs for the accuracy requirement of the target service; and initiating the SL positioning procedure with the second UE in response to determining to use the SL positioning method.

In some embodiments of the present application, the second UE helps the first UE to acquire its position, and the method further includes: receiving positioning assistance data which includes SL PRS information; and initiating the SL positioning procedure with the second UE in response to receiving the positioning assistance data.

In some embodiments of the present application, the abort message includes an identification associated with the SL positioning procedure.

In some embodiments of the present application, the abort message is an RRC message, and the identification is a layer-2 ID associated with the SL positioning procedure.

In some embodiments of the present application, the abort message is an upper layer message.

In some embodiments of the present application, the method further includes receiving an abort message including the identification associated with the SL positioning procedure from a network.

In some embodiments of the present application, the second UE helps the first UE to acquire its position, and the method further includes: transmitting the abort message to the second UE in response to at least one of the following conditions: a target service is cancelled by the first UE; the first UE receives an abort message associated with the SL positioning procedure from an LMF; an SL positioning method cannot guarantee an accuracy requirement of a target service of the first UE; or the first UE decides to abort the SL positioning procedure by the first UE's implementation.

In some embodiments of the present application, the SL positioning method cannot guarantee the accuracy requirement of the target service of the first UE when at least one of the following conditions occurs: a new positioning method different from the SL positioning method is available for the first UE and the first UE determines to change to use the new positioning method; a number of available anchor UEs for the first UE is lower than a minimum number of anchor UEs for the accuracy requirement of the target service; or new PRS information different from current PRS information is acquired by the first UE.

In some embodiments of the present application, the first UE helps the second UE to acquire its position, and the method further includes: transmitting the abort message to the second UE in response to at least one of the following conditions: a positioning capability of the first UE to support the SL positioning procedure changes; the first UE receives an abort message associated with the SL positioning procedure from an LMF; or the first UE decides to abort the SL positioning procedure by the first UE's implementation.

In some embodiments of the present application, the second UE helps the first UE to acquire its position, and the method further includes receiving new PRS information different from current PRS information in or along with an abort message associated with the SL positioning procedure from a network, wherein the new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, the method further includes receiving positioning assistance data, wherein the new PRS information and the abort message associated with the SL positioning procedure are included in the positioning assistance data.

In some embodiments of the present application, the first UE helps the second UE to acquire its position, and the method further includes receiving new PRS information different from current PRS information in or along with an abort message associated with the SL positioning procedure from a network, wherein the new PRS information includes at least one of: new anchor UE information different from current anchor UE information or an indication to trigger an SL anchor UE selection or reselection procedure; a PRS configuration or an SRS configuration related to RAT-dependent positioning; or a new SL PRS configuration related to SL positioning different from a current SL PRS configuration; and transmitting the received new PRS information in or along with the abort message that is transmitted to the second UE.

In some embodiments of the present application, the second UE helps the first UE to acquire its position, and the method further includes: transmitting a PRS information request to a network to acquire new PRS information different from current PRS information before transmitting the abort message; and receiving the new PRS information before transmitting the abort message, wherein the new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, the first UE helps the second UE to acquire its position, and the method further includes transmitting an indication to a network to indicate that the SL positioning procedure will be aborted before transmitting the abort message.

In some embodiments of the present application, the method further includes: receiving new PRS information different from current PRS information from the network; and transmitting the received new PRS information in or along with the abort message to the second UE, wherein the new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, aborting the SL positioning procedure includes aborting at least one of: a positioning capability transfer procedure between the first UE and the second UE; an SL PRS configuration procedure between the first UE and the second UE; an SL PRS transmission procedure between the first UE and the second UE; or a measurement reporting procedure between the first UE and the second UE.

According to some embodiments of the present application, a method performed by a second UE may include: performing an SL positioning procedure with a first UE; receiving an abort message to abort the SL positioning procedure from the first UE; and aborting the SL positioning procedure in response to receiving the abort message.

In some embodiments of the present application, aborting the SL positioning procedure includes aborting at least one of: a positioning capability transfer procedure between the first UE and the second UE; an SL PRS configuration procedure between the first UE and the second UE; an SL PRS transmission procedure between the first UE and the second UE; or a measurement reporting procedure between the first UE and the second UE.

In some embodiments of the present application, the first UE helps the second UE to acquire its position, and the method further includes: in the case that an SL positioning method and at least one of an RAT-dependent positioning method or RAT-independent positioning method are available for the second UE, determining to use the SL positioning method based on at least one of an accuracy requirement or a latency requirement of a target service; in the case that only the SL positioning method is available for the second UE, determining to use the SL positioning method in response to at least one of the followings: SL PRS information for the second UE satisfies the accuracy requirement of the target service; or a number of anchor UEs discovered by the second UE is larger than or equal to a minimum number of anchor UEs for the accuracy requirement of the target service; and initiating the SL positioning procedure with the first UE in response to determining to use the SL positioning method.

In some embodiments of the present application, the first UE helps the second UE to acquire its position, and the method further includes: receiving positioning assistance data which includes SL PRS information; and initiating the SL positioning procedure with the first UE in response to receiving the positioning assistance data.

In some embodiments of the present application, the abort message includes an identification associated with the SL positioning procedure.

In some embodiments of the present application, the abort message is an RRC message, and the identification is a layer-2 ID associated with the SL positioning procedure.

In some embodiments of the present application, the abort message is an upper layer message.

In some embodiments of the present application, the first UE helps the second UE to acquire its position, and the method further includes: receiving new PRS information different from current PRS information from a network, wherein the new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, the first UE helps the second UE to acquire its position, and the method further includes: receiving new PRS information different from current PRS information in or along with the abort message from the first UE, wherein the new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

Embodiments of the present application provide technical solutions for SL positioning, which include but are not limited to apparatuses and methods for initiating SL positioning, aborting SL positioning, or switching SL positioning to another positioning method.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary Uu positioning procedure according to some embodiments of the present application;

FIG. 3 illustrates an exemplary abort procedure according to some embodiments of the present application;

FIG. 4 is a flow chart illustrating an exemplary method for SL positioning according to some embodiments of the present application;

FIG. 5 illustrates an exemplary abort procedure of SL positioning according to some embodiments of the present application;

FIG. 6 illustrates another exemplary abort procedure of SL positioning according to some other embodiments of the present application;

FIG. 7 illustrates yet another exemplary abort procedure of SL positioning according to some other embodiments of the present application;

FIG. 8 illustrates yet another exemplary abort procedure of SL positioning according to some other embodiments of the present application; and

FIG. 9 illustrates a simplified block diagram of an exemplary apparatus for SL positioning according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., new radio (NR)), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

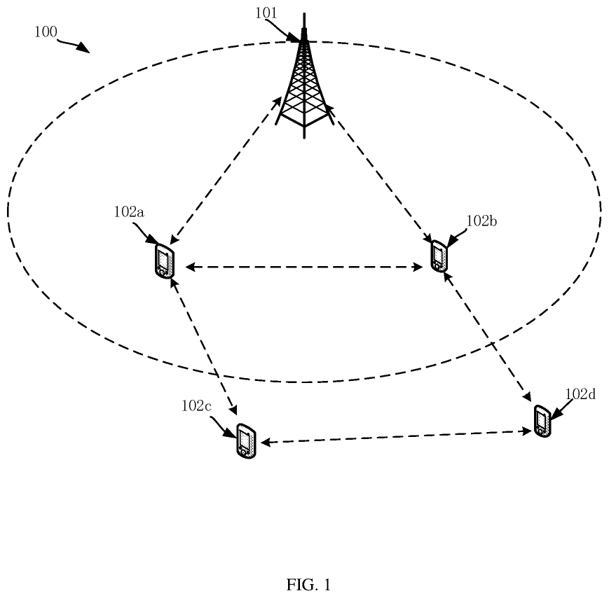

FIG. 1 is a schematic diagram illustrating an exemplary wireless communication system 100 according to some embodiments of the present application.

As shown in FIG. 1, the wireless communication system 100 includes at least one base station (BS) 101 and at least one UE (e.g., a UE 102a, a UE 102b, a UE 102c, and a UE 102d). Although one BS and four UEs are depicted in FIG. 1 for illustrative purpose, it is contemplated that any number of BSs and UEs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

According to some embodiments of the present application, the UE 102a, the UE 102b, the UE 102c, and the UE 102d may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a, the UE 102b, the UE 102c, and the UE 102d may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a, the UE 102b, the UE 102c, and the UE 102d may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a, the UE 102b, the UE 102c, and the UE 102d may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the BS 101, and may transmit information or data to the BS 101 and receive control information or data from the BS 101, for example, via LTE or NR Uu interface.

The UE 102c and the UE 102d are outside the coverage area of the BS 101. The UE 102a may communicate with the UE 102b and the UE 102c via SL (for example, via PC5 interface as defined in 3GPP standard documents), and the UE 102d may communicate with the UE 102b and the UE 102c via SL.

When a location service request is initiated or occurs at a UE, the UE (referred to as target UE or location service (LCS) target UE) needs to know its own position. When the target UE is within a coverage area of a BS or network (i.e., in coverage), the target UE may get positioning information from the BS or network, which is known as Uu positioning or NR Uu positioning. When the target UE is outside a coverage area of any BS or network (i.e., out of coverage), the target UE cannot get positioning information from any BS or network. According to various embodiments of the present disclosure, regardless of in coverage or out of coverage, the target UE (also referred to as SL target UE) may select one or more other UEs to be anchor UE(s) (also referred to as SL anchor UE(s)), which may participate in SL positioning and help the SL target UE to acquire its position, e.g., by sending/receiving SL PRS and doing relevant measurements. The SL anchor UE should have positioning capability, and may be a roadside unit (RSU) or any SL UE.

When performing SL positioning, the SL target UE and the SL anchor UE may be both in coverage (i.e., “both in coverage” scenario), or one in coverage and the other out of coverage (i.e., “partial coverage” scenario), or both out of coverage (i.e., “both out of coverage” scenario).

In an embodiment, the UE 102a may act as an SL target UE. The UE 102a may select the UE 102b to be an SL anchor UE to assist the UE 102a to acquire its position, which is in the “both in coverage” scenario. Alternatively or additionally, the UE 102a may select the UE 102c to be an SL anchor UE to assist the UE 102a to acquire its position, which is in the “partial coverage” scenario. It should be understood that the UE 102a may alternatively or additionally select other SL anchor UE(s) not shown in FIG. 1.

In an embodiment, the UE 102d may act as an SL target UE. The UE 102d may select the UE 102b to be an SL anchor UE to assist the UE 102d to acquire its position, which is in the “partial coverage” scenario. Alternatively or additionally, the UE 102d may select the UE 102c to be an SL anchor UE to assist the UE 102d to acquire its position, which is in the “both out of coverage” scenario. It should be understood that the UE 102d may alternatively or additionally select other SL anchor UE(s) not shown in FIG. 1. The SL anchor UE(s) selected by the UE 102d may be different from the SL anchor UE(s) selected by the UE 102a.

In the “both in-coverage” scenario and “partial coverage” scenario, the NR Uu positioning, the NR SL positioning, or the RAT-independent positioning can be applied for a UE to support different location service requests. The NR Uu positioning may include RAT-dependent positioning. The RAT-dependent positioning may mean that the UE's position is calculated based on reference signal (e.g., SRS, PRS, and/or other reference signal) measurement(s) in Uu interface. The RAT-independent positioning may mean that the positioning is not related to the reference signal(s) in Uu interface (e.g., wireless local area network (WLAN) positioning, Bluetooth positioning, global navigation satellite system (GNSS) positioning, etc.). Since the location services and UE positioning capabilities are various, the applicable positioning methods for a UE may be changed due to some external conditions, and thus the corresponding initiation conditions for a positioning method and abort conditions for a positioning method need to be defined.

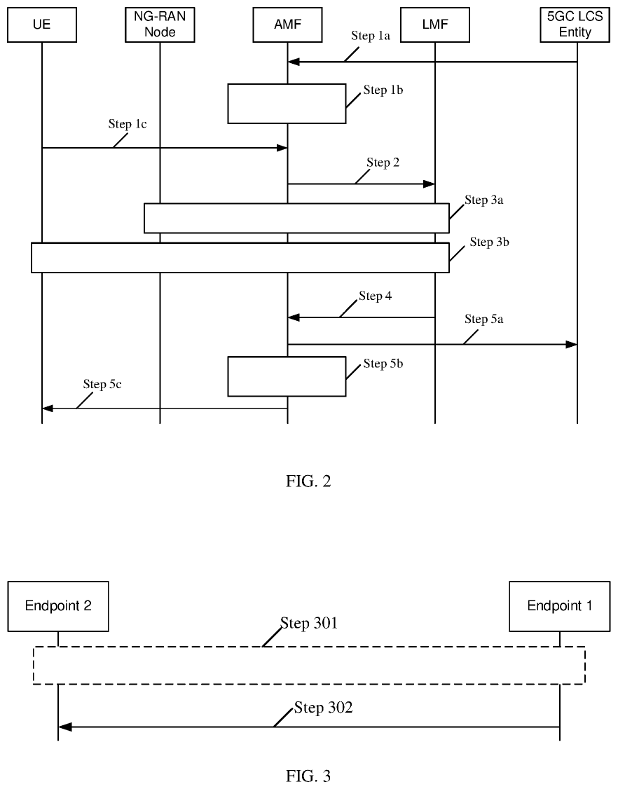

In the NR Uu positioning procedure, a UE and an LMF may coordinate positioning related information by LTE positioning protocol (LPP) signaling. FIG. 2 illustrates an exemplary Uu positioning procedure according to some embodiments of the present application.

Referring to FIG. 2, in step 1a, a 5G core network (5GC) LCS entity (e.g., gateway mobile location center (GMLC)) may transmit a location service request to a access and mobility management function (AMF) serving a UE to request one or more location services (e.g. a positioning service) for the UE, which is also referred to as a target UE. The one or more location services may need to know the position of the UE.

Alternatively or additionally, in step 1b, the AMF serving the UE may determine the need for one or more location services (e.g., to locate the UE for an emergency call) and generate a location service request.

Alternatively or additionally, in step 1c, the UE may transmit a location service request to the serving AMF at a non-access-stratum (NAS) level to request one or more location services (e.g., positioning service or delivery of assistance data).

In step 2, the AMF may transfer the location service request to an LMF.

In step 3a, the LMF may instigate location procedure(s) with the serving next generation radio access network (NG-RAN) node (e.g., ng-eNB or gNB) and possibly neighboring NG-RAN node(s), e.g., to obtain positioning measurement(s) or assistance data. Additionally or alternatively, in step 3b, the LMF may instigate location procedure(s) with the UE, e.g., to obtain a location estimate or positioning measurement(s) or to transfer location assistance data to the UE.

In step 4, the LMF may provide a location service response to the AMF. The location service response may include any needed result(s), e.g., success or failure indication for the location service request, or a location estimate for the UE if the location estimate is requested by the AMF and obtained by the LMF.

In the case that step 1a is performed, step 5a may be performed. In step 5a, the AMF may return a location service response to the 5GC LCS entity from which the location service request is received. The location service response may include any needed result(s) received by the AMF in step 4, e.g., a location estimate for the UE.

In the case that step 1b is performed, step 5b may be performed. In step 5b, the AMF may use the location service response received in step 4 to assist the one or more location services which triggered the location service request in step 1b (e.g., the AMF may provide a location estimate associated with an emergency call to a GMLC).

In the case that step 1c is performed, step 5c may be performed. In step 5c, the AMF may return a location service response to the UE from which the location service request is received. The location service response may include any needed result(s) received by the AMF in step 4, e.g., a location estimate for the UE.

During the procedure illustrated in FIG. 2, the UE may provide at least one of the following functions.
The UE may make measurements of downlink signals from NG-RAN and other sources such as evolved universal mobile telecommunications system (UMTS) terrestrial radio access network (E-UTRAN), GNSS, terrestrial beacon systems (TBS), WLAN access points, Bluetooth beacons, UE barometric pressure and motion sensors, etc. The measurements to be made will be determined by the selected positioning method.
The UE may contain an LCS application, or access an LCS application either through communication with a network accessed by the UE or through another application residing in the UE. This LCS application may include the needed measurement and calculation functions to determine the UE's position with or without network assistance.
The UE may contain an independent positioning function (e.g., GPS) and thus be able to report its position independent of the NG-RAN transmissions. The UE with an independent positioning function may also make use of assistance information obtained from the network.

During the procedure illustrated in FIG. 2, the NG-RAN node may provide at least one of the following functions.
The NG-RAN node is a network element of NG-RAN that may provide measurement information for a target UE and communicates the measurement information to the LMF.
To support RAT-dependent positioning, the NG-RAN node may make measurements of radio signals for a target UE, and provide measurement results for position estimation. In some embodiments, the NG-RAN node may serve several transmit-receive point (TRPs), e.g., remote radio heads, and uplink sounding reference signal (UL-SRS) only receive points (RPs) and downlink positioning reference signal (DL-PRS) only transmit points (TPs).
The NG-RAN node may broadcast assistance data information, which is received from the LMF, in positioning system information message(s).

During the procedure illustrated in FIG. 2, the LMF may provide at least one of the following functions.
The LMF may manage the support of different location services for target UEs, (e.g., positioning of UEs and delivery of assistance data to UEs). The LMF may interact with the serving NG-RAN node for a target UE in order to obtain position measurements for the UE, including uplink measurements made by an NG-RAN and downlink measurements made by the UE that were provided to an NG-RAN as part of other functions such as for support of handover.
The LMF may interact with a target UE in order to deliver assistance data if the assistance data was requested for a particular location service, or to obtain a location estimate if the location estimate was requested.
The LMF may interact with multiple NG-RAN nodes to provide assistance data information for broadcasting. The assistance data information for broadcasting may optionally be segmented and/or ciphered by the LMF. The LMF may also interact with AMFs to provide ciphering key data information to the AMF as described in TS 23.273.
For positioning of a target UE, the LMF may decide the position method(s) to be used based on factors that may include the LCS client type, the required quality of service (QoS), UE positioning capabilities, NG-RAN node positioning capabilities, etc. Then, the LMF may invoke the positioning method(s) in at least one of the UE or the NG-RAN node. The positioning method(s) may yield at least one of a location estimate for UE-based position method(s) or positioning measurement(s) for UE-assisted and network-based position method(s). The LMF may combine all the received result(s) and determine a single location estimate for the target UE (i.e., hybrid positioning). Additional information such as accuracy of the location estimate and velocity may also be determined.

In some cases, as the location service changes and/or UE positioning capability changes (e.g., the UE moves out of coverage of the NG-RAN), the procedure in FIG. 2 may be aborted. FIG. 3 illustrates an exemplary abort procedure according to some embodiments of the present application, which can be used to abort the Uu positioning procedure as shown in FIG. 2.

The procedure illustrated in FIG. 3 may be used by endpoint 1 to notify endpoint 2 to abort an ongoing procedure between the two endpoints. One of the two endpoints is a target while the other is a server. This procedure is bidirectional at the LPP level. That is, either the target or the server may take the role of either endpoint.

When the procedure illustrated in FIG. 3 is used to abort the positioning procedure illustrated in FIG. 2, the target may be the UE or the NG-RAN node, and the server may be the LMF. In step 301, the UE or the NG-RAN node may perform a positioning procedure with the LMF.

In some cases, the LMF may determine that the positioning procedure must be aborted. Then, in step 302, the LMF may send an LPP abort message to the UE or the NG-RAN node. The LPP abort message may carry an ID associated with the positioning procedure.

In some other cases, the UE or the NG-RAN node may determine that the positioning procedure must be aborted. Then, in step 302, the UE or the NG-RAN node may send an LPP abort message to the LMF. The LPP abort message may carry an ID associated with the positioning procedure.

FIG. 2 and FIG. 3 illustrate the positioning procedure and abort procedure for Uu positioning. Referring to FIG. 2 and FIG. 3, in Uu Positioning, the UE (and/or the NG-RAN node) and the LMF may coordinate positioning related information by LPP signaling. However, in SL positioning, UEs may need to negotiate coordination information over sidelink. Then, how to initiate SL positioning (e.g., conditions to initiate SL positioning), how to abort SL positioning (e.g., conditions to abort SL positioning), and/or how to switch from SL positioning to other positioning after aborting SL positioning need to be addressed.

Given this, embodiments of the present application propose methods for SL positioning, which provide various technical solutions regarding initiating SL positioning (e.g., conditions to initiate SL positioning), aborting SL positioning (e.g., conditions to abort SL positioning), and/or switching from SL positioning to other positioning (e.g., signaling optimization for switching from SL positioning to other positioning). More details on embodiments of the present application will be described in the following text in combination with the appended drawings.

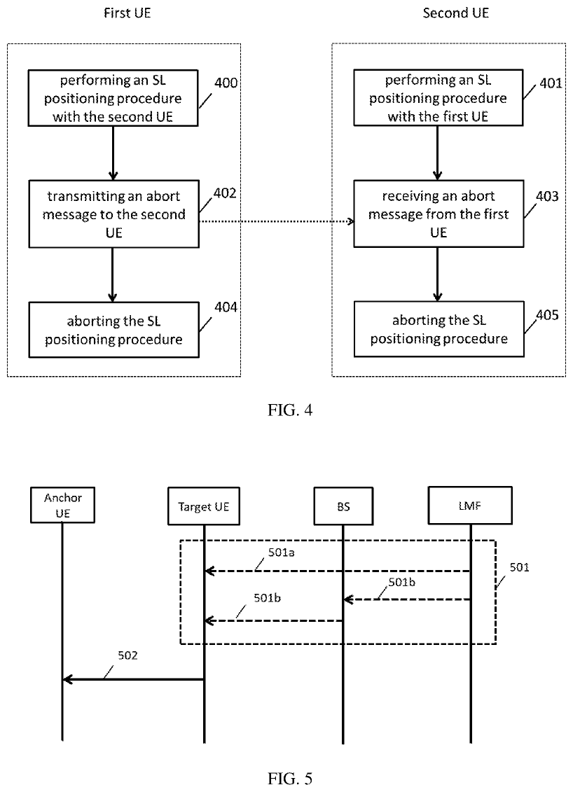

FIG. 4 is a flow chart illustrating an exemplary method for SL positioning according to some embodiments of the present application. Although the method is illustrated in a system level by two devices, e.g., a first UE and a second UE, persons skilled in the art can understand that the method implemented in the first UE and that implemented in the second UE can be separately implemented and incorporated by other apparatus with the like functions. In some embodiments of the present application, the first UE may be a target UE and the second UE may be an anchor UE. In some other embodiments, the first UE may be an anchor UE and the second UE may be a target UE. The target UE may be a UE at which a location service request is initiated or occurs. In other words, the target UE may be a UE that wants to know its own position. The anchor UE may be a UE or RSU that participates in SL positioning and helps the target UE to acquire its position, e.g., by sending/receiving SL PRS and doing relevant measurements.

For example, the target UE may be UE 102a as shown in FIG. 1 and the anchor UE may be UE 102b or UE 102c as shown in FIG. 1. In another example, the target UE may be UE 102d as shown in FIG. 1 and the anchor UE may be UE 102b or UE 102c as shown in FIG. 1.

When a target service is initiated or occurs at the target UE, specific positioning method(s) need be determined for the target service to acquire position result(s) of the target UE.

In Uu positioning, the LMF may decide the positioning method(s) to be used based on factors that may include the LCS client type, the required QoS, UE positioning capabilities, NG-RAN node positioning capabilities, etc. Then, the LMF may invoke the positioning method(s) in at least one of the UE or the NG-RAN node.

However, for SL positioning, since the target UE may be an out-of-coverage UE and cannot register to the LMF, the positioning method determination should be re-considered if SL positioning is introduced.

According to some embodiments of the present application, the positioning method may be determined by the target UE. In such embodiments, a location service request associated with the target service may be initiated from the target UE side.

In an embodiment of the present application, both an SL positioning method and at least one of an RAT-dependent positioning method or an RAT-independent positioning method are available for the target UE (e.g., UE 102a in FIG. 1). The target UE may determine to use Uu positioning (e.g., RAT-dependent positioning method), RAT-independent positioning, or SL positioning based on at least one of an accuracy requirement or a latency requirement of the target service. For example, the target UE may determine to use the SL positioning method based on at least one of an accuracy requirement or a latency requirement of the target service. In some embodiments, the target UE may determine to use the SL positioning method when the SL positioning method is able to achieve a higher accuracy and/or lower latency than the RAT-dependent positioning method or RAT-independent positioning method.

In another embodiment of the present application, only the SL positioning method is available for the target UE (i.e., both RAT-dependent positioning method and RAT-independent positioning method are not available for the target UE, for example, UE 102d in FIG. 1). Then, the target UE may determine to use the SL positioning method in response to at least one of the followings: SL PRS information for the target UE satisfies the accuracy requirement of the target service; or a number of anchor UEs discovered by the target UE is larger than or equal to a minimum number of anchor UEs for the accuracy requirement of the target service. The SL PRS information may include SL PRS configuration (e.g., periodicity, bandwidth, reception time, resource used for transmission, etc.) and/or some other information related to the SL PRS but not included in the SL PRS configuration.

In response to determining to use the SL positioning method, the target UE may initiate an SL positioning procedure with an anchor UE. As shown in FIG. 4, in steps 400 and 401, the target UE and the anchor UE may perform the SL positioning procedure with each other.

According to some other embodiments of the present application, the positioning method may be determined by the network side (e.g., LMF). In such embodiments, a location service request associated with the target service may be initiated from the network side or the target UE may transmit a location service request to the network side.

In some embodiments of the present application, the network side may determine whether to use a Uu positioning method or an SL positioning method based on factors that may include the LCS client type, the required QoS, UE positioning capabilities, NG-RAN node positioning capabilities, etc.

In the case that the network side determines to use the SL positioning method, the network side may transmit positioning assistance data to the target UE. The positioning assistance data may include SL PRS information. The presence of the SL PRS information in the positioning assistance data may implicitly indicate to the target UE to use the SL positioning method. In response to receiving the positioning assistance data, the target UE may initiate the SL positioning procedure with an anchor UE. As shown in FIG. 4, in steps 400 and 401, the target UE and the anchor UE may perform the SL positioning procedure with each other.

The SL positioning procedure may include at least one of: a positioning capability transfer procedure between the target UE and the anchor UE, in which the target UE and the anchor UE may exchange their capabilities related to positioning over sidelink; an SL PRS configuration procedure between the target UE and the anchor UE, in which the SL PRS configuration is provided from the target UE to the anchor UE or from the anchor UE to the target UE over sidelink; an SL PRS transmission procedure between the target UE and the anchor UE, in which the SL PRS transmission and reception is performed between the target UE and the anchor UE over sidelink based on the SL PRS configuration; or a measurement reporting procedure between the target UE and the anchor UE, in which the target UE or the anchor UE performs SL PRS measurement (e.g., reference signal received power (RSRP) value, timing point, etc.) and reports the measurement results to peer UE or to the network. Aborting the SL positioning procedure may include aborting any of these procedures that is ongoing.

In some cases, the SL positioning procedure may be aborted due to some unexpected event. In such cases, at least one of the network side, the anchor UE, or the target UE may determine that the SL positioning procedure should be aborted.

According to some embodiments of the present application, the first UE is the target UE and the second UE is the anchor UE. The target UE may determine to abort the SL positioning procedure. Then, in step 402, the target UE may transmit an abort message to abort the SL positioning procedure to the anchor UE.

The target UE may transmit the abort message to the anchor UE in response to at least one of the following conditions:
The target service is cancelled by the target UE.
The target UE receives an abort message associated with the SL positioning procedure from an LMF. In some embodiments, the abort message may be transmitted from the LMF to the target UE by an LPP signaling. In some other embodiments, the abort message may be transmitted from the LMF to a BS serving the target UE (e.g., by an NR positioning protocol A (NRPPa) signaling) first, and then be transmitted from the BS to the target UE (e.g., by an RRC signaling or a positioning system information block (PosSIB)).
An SL positioning method cannot guarantee an accuracy requirement of the target service of the target UE.
The target UE decides to abort the SL positioning procedure by the target UE's implementation.

In some embodiments of the present application, the SL positioning method cannot guarantee the accuracy requirement of the target service of the target UE when at least one of the following conditions occurs:
A new positioning method different from the SL positioning method is available for the target UE and the target UE determines to change to use the new positioning method. That is, the target UE acquires a new positioning capability (for example, when the GNSS becomes reliable, or an RAT-dependent positioning method is available).
A number of available anchor UEs for the target UE is lower than a minimum number of anchor UEs for the accuracy requirement of the target service.
New PRS information (or new PRS configuration) different from current PRS information is acquired by the target UE. The current PRS information or configuration refers to the PRS information or configuration used by the target UE to perform the ongoing SL positioning procedure with the anchor UE.

In some embodiments of the present application, the abort message transmitted from the target UE to the anchor UE may include an identification associated with the SL positioning procedure.

In an embodiment of the present application, the RRC layer may generate message(s) including positioning information. In such embodiment, the abort message transmitted from the target UE is an RRC message, and the identification associated with the SL positioning procedure is a layer-2 ID associated with the SL positioning procedure, which is used to identify the RRC connection for positioning.

In another embodiment of the present application, the upper layer (e.g., a V2X layer or a position layer) may generate message(s) including positioning information. In such embodiment, the abort message transmitted from the target UE is an upper layer message which includes the identification associated with the SL positioning procedure.

According to some embodiments of the present application, the first UE is the anchor UE and the second UE is the target UE. The anchor UE may determine to abort the SL positioning procedure. Then, in step 402, the anchor UE may transmit an abort message to abort the SL positioning procedure to the target UE.

The anchor UE may transmit the abort message to the target UE in response to at least one of the following conditions:
A positioning capability of the anchor UE to support the SL positioning procedure changes. In some embodiments of the present application, the positioning capability of the anchor UE changing may mean that the current positioning capability (or the current positioning method) of the anchor UE is not available, e.g., the RAT-dependent positioning method is unavailable when the anchor UE is moving out of network coverage, or the GNSS for the anchor UE is unreliable.
The anchor UE receives an abort message associated with the SL positioning procedure from an LMF. In some embodiments, the abort message may be transmitted from the LMF to the anchor UE by an LPP signaling. In some other embodiments, the abort message may be transmitted from the LMF to a BS serving the anchor UE (e.g., by an NRPPa signaling) first, and then be transmitted from the BS to the anchor UE (e.g., by an RRC signaling or a PosSIB).
The anchor UE decides to abort the SL positioning procedure by the anchor UE's implementation.

In some embodiments of the present application, the abort message transmitted from the anchor UE to the target UE may include an identification associated with the SL positioning procedure.

In an embodiment of the present application, the RRC layer may generate message(s) including positioning information. In such embodiment, the abort message transmitted from the anchor UE is an RRC message, and the identification associated with the SL positioning procedure is a layer-2 ID associated with the SL positioning procedure, which is used to identify the RRC connection for positioning.

In another embodiment of the present application, the upper layer (e.g., a V2X layer or a position layer) may generate message(s) including positioning information. In such embodiment, the abort message transmitted from the anchor UE is an upper layer message which includes the identification associated with the SL positioning procedure.

According to some other embodiments of the present application, the network side (e.g., LMF) may determine to abort the SL positioning procedure. In such embodiments, the network side may transmit an abort message associated with the SL positioning procedure to the first UE, wherein the first UE may be a target UE or an anchor UE. The abort message may include an identification associated with the SL positioning procedure. After receiving the abort message from the network side, the first UE may transmit the abort message to the second UE (e.g., in step 402). The second UE may be an anchor UE in the case that the first UE is a target UE, or the second UE may be a target UE in the case that the first UE is an anchor UE. The network side may transmit the abort message in at least one of the following scenarios: (1) both the target UE and the anchor UE are in-coverage, (2) either the target UE or the anchor UE is in-coverage, or (3) the network side provides PRS information for SL positioning

Based on the above, in step 402, the first UE (i.e., the target UE or the anchor UE) may transmit the abort message to the second UE (i.e., the anchor UE in the case that the first UE is a target UE, or the target UE in the case that the first UE is the anchor UE). Consequently, in step 403, the second UE may receive the abort message from the first UE. In step 404, the first UE may abort the SL positioning procedure in response to transmitting the abort message. In step 405, the second UE may abort the SL positioning procedure in response to receiving the abort message. For example, the first UE or the second UE may abort the SL positioning procedure associated with the identification included in the abort message.

In some embodiments of the present application, aborting the SL positioning procedure may include aborting at least one of:
a positioning capability transfer procedure between the first UE and the second UE, in which the first UE and the second UE may exchange their capabilities related to positioning over sidelink;
an SL PRS configuration procedure between the first UE and the second UE, in which the SL PRS configuration is provided from the first UE to the second UE or from the second UE to the first UE over sidelink;
an SL PRS transmission procedure between the first UE and the second UE, in which the SL PRS transmission and reception is performed between the first UE and the second UE over sidelink based on the SL PRS configuration; or
a measurement reporting procedure between the first UE and the second UE, in which the first UE or the second UE performs SL PRS measurement (e.g., RSRP value, timing point, etc.) and reports the measurement results to peer UE or to the network.

In some cases, when the current SL positioning procedure is aborted due to some events, another positioning procedure (e.g., an RAT-dependent positioning method if available) may to be initiated for the target UE to acquire positioning result(s). In such cases, the following embodiments design and optimize related signaling when a target UE changes the current SL positioning to another positioning procedure, thereby avoiding unnecessary latency.

FIG. 5 illustrates an exemplary abort procedure of SL positioning according to some embodiments of the present application. In the embodiments of FIG. 5, a network (e.g., LMF) initiates the abort procedure and transmits an abort message to a target UE. The abort message is associated with an ongoing SL positioning procedure between the target UE and an anchor UE. The procedure of FIG. 5 may be applied to “both in-coverage” scenario or “partial coverage” scenario where the target UE is in-coverage.

Referring to FIG. 5, in step 501, the network may transmit new PRS information different from the current PRS information in or along with the abort message associated with the SL positioning procedure to the target UE. In some embodiments of the present application, the new PRS information may include at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from the current SL PRS configuration.

Step 501 may be implemented by step 501a or step 501b. In step 501a, the network may transmit the new PRS information in or along with the abort message directly to the target UE (e.g., by an LPP signaling). In step 501b, the network may first transmit the new PRS information in or along with the abort message to a BS serving the target UE (e.g., by an NRPPa signaling), and then the BS may transmit the new PRS information in or along with the abort message to the target UE (e.g., by an RRC signaling or a PosSIB).

After receiving the new PRS information in or along with the abort message, in step 502, the target UE may transmit the abort message to the anchor UE (e.g., in a manner as described above with respect to step 402 in FIG. 4). The abort message transmitted in step 502 may not include the new PRS information.

In some embodiments, in step 501, the network may transmit positioning assistance data to the target UE. The positioning assistance data may include the above new PRS information and the abort message associated with the SL positioning procedure. Similarly, the positioning assistance data may be directly transmitted to the target UE in step 501a or first transmitted to the BS and then transmitted to the target UE in step 501b.

After receiving the positioning assistance data, in step 502, the target UE may transmit the abort message to the anchor UE.

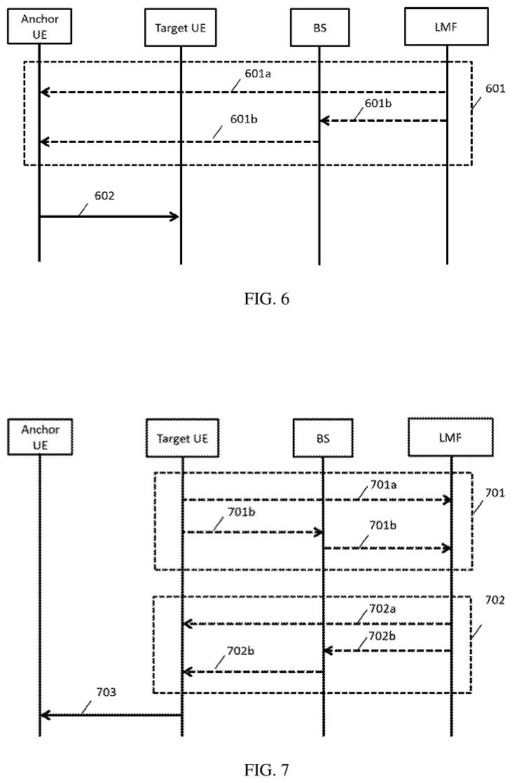

FIG. 6 illustrates another exemplary abort procedure of SL positioning according to some other embodiments of the present application. In the embodiments of FIG. 6, a network (e.g., LMF) initiates the abort procedure and transmits an abort message to an anchor UE. The abort message is associated with an ongoing SL positioning procedure between the anchor UE and a target UE. The procedure of FIG. 6 may be applied to “both in-coverage” scenario or “partial coverage” scenario where the anchor UE is in-coverage.

Referring to FIG. 6, in step 601, the network may transmit new PRS information different from the current PRS information in or along with the abort message associated with the SL positioning procedure to the anchor UE. In some embodiments of the present application, the new PRS information may include at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from the current SL PRS configuration.

Step 601 may be implemented by step 601a or step 601b. In step 601a, the network may transmit the new PRS information in or along with the abort message directly to the anchor UE (e.g., by an LPP signaling). In step 601b, the network may first transmit the new PRS information in or along with the abort message to a BS serving the anchor UE (e.g., by an NRPPa signaling), and then the BS may transmit the new PRS information in or along with the abort message to the anchor UE (e.g., by an RRC signaling or a PosSIB).

After receiving the new PRS information in or along with the abort message, in step 602, the anchor UE may transmit the new PRS information in or along with the abort message to the target UE (e.g., in a manner as described above with respect to step 402 in FIG. 4).

In some embodiments, in step 601, the network may transmit positioning assistance data to the anchor UE. The positioning assistance data may include the above new PRS information and the abort message associated with the SL positioning procedure. Similarly, the positioning assistance data may be directly transmitted to the anchor UE in step 601a or first transmitted to the BS and then transmitted to the anchor UE in step 601b.

After receiving the positioning assistance data, in step 602, the anchor UE may transmit the abort message to the target UE.

FIG. 7 illustrates yet another exemplary abort procedure of SL positioning according to some other embodiments of the present application. In the embodiments of FIG. 7, a target UE initiates the abort procedure and transmits the abort message to the anchor UE. The abort message is associated with an ongoing SL positioning procedure between the target UE and the anchor UE.

Referring to FIG. 7, in step 701, the target UE may transmit a PRS information request to a network (e.g., LMF) to acquire new PRS information different from current PRS information. Step 701 may be implemented by step 701a or step 701b. In step 701a, the target UE may transmit the PRS information request directly to the network (e.g., by an LPP signaling). In step 701b, the target UE may first transmit the PRS information request to a BS serving the target UE (e.g., by an RRC signaling), and then the BS may transmit the PRS information request to the network (e.g., by an NRPPa signaling).

After receiving the PRS information request, in step 702, the network may transmit the new PRS information to the target UE. In some embodiments of the present application, the new PRS information may include at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from the current SL PRS configuration.

Step 702 may be implemented by step 702a or step 702b. In step 702a, the network may transmit the new PRS information directly to the target UE (e.g., by an LPP signaling). In step 702b, the network may first transmit the new PRS information to a BS serving the target UE, and then the BS may transmit the new PRS information to the target UE (e.g., by an RRC signaling or a positioning system information block (PosSIB)).

After receiving the new PRS information, in step 703, the target UE may transmit the abort message to the anchor UE (e.g., in a manner as described above with respect to step 402 in FIG. 4).

FIG. 8 illustrates another exemplary abort procedure of SL positioning according to some other embodiments of the present application. In the embodiments of FIG. 8, an anchor UE initiates the abort procedure and transmits the abort message to a target UE. The abort message is associated with an ongoing SL positioning procedure between the target UE and the anchor UE.

Referring to FIG. 8, in step 801, the anchor UE may transmit an indication to a network (e.g., LMF) to indicate that the SL positioning procedure will be aborted. Step 801 may be implemented by step 801a or step 801b. In step 801a, the anchor UE may transmit the indication directly to the network (e.g., by an LPP signaling). In step 801b, the target UE may first transmit the indication to a BS serving the anchor UE (e.g., by an RRC signaling), and then the BS may transmit the indication to the network (e.g., by an NRPPa signaling).

After receiving the indication, in step 802a, the network may transmit new PRS information different from current PRS information to the target UE. The new PRS information may include at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from the current SL PRS configuration. In some embodiments of the present application, the new PRS information may be transmitted in positioning assistance data to the target UE. Similarly, the network may transmit the new PRS information directly to the target UE (e.g., by an LPP signaling), or the network may first transmit the new PRS information to a BS serving the target UE and then the BS may transmit the new PRS information to the target UE (e.g., by an RRC signaling or a PosSIB).

In step 803, the anchor UE may transmit the abort message to the target UE. Step 802a may occur simultaneously with, before, or after step 803.

In some other embodiments, step 802a may be not performed while step 802b may be performed. In step 802b, the network may transmit the new PRS information different from the current PRS information to the anchor UE. In some embodiments of the present application, the new PRS information may be transmitted in positioning assistance data to the anchor UE. Similarly, the network may transmit the new PRS information directly to the anchor UE (e.g., by an LPP signaling), or the network may first transmit the new PRS information to a BS serving the anchor UE and then the BS may transmit the new PRS information to the anchor UE (e.g., by an RRC signaling or a PosSIB).

Then, after receiving the new PRS information, in step 803, the anchor UE may transmit the received new PRS information from the network in or along with the abort message to the target UE (e.g., in a manner as described above with respect to step 402 in FIG. 4).

In some embodiments of the present application, before the new PRS information or a new SL anchor UE is available for the target UE, the target UE and the anchor UE may perform the SL positioning procedure using the current PRS information.

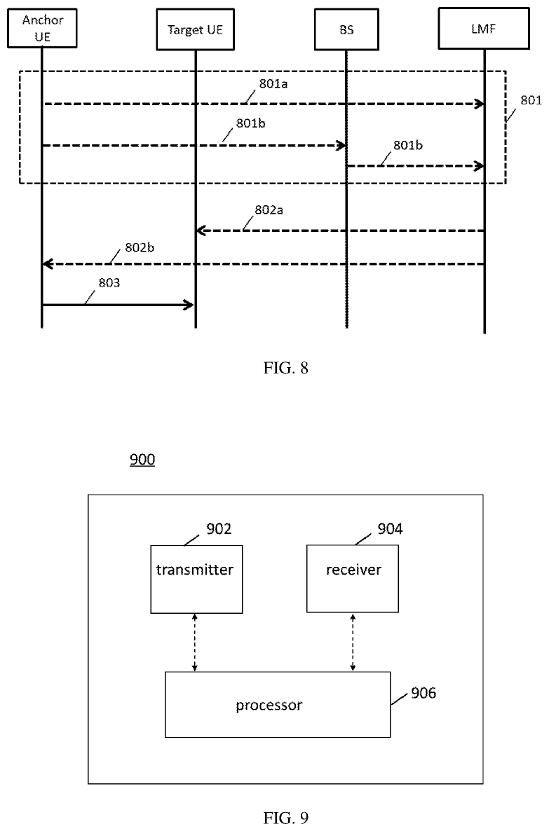

FIG. 9 illustrates a simplified block diagram of an exemplary apparatus 900 for SL positioning according to some embodiments of the present application. The apparatus 900 may be or include at least part of a UE (e.g., a target UE or an anchor UE).

Referring to FIG. 9, the apparatus 900 may include at least one transmitter 902, at least one receiver 904, and at least one processor 906. The at least one transmitter 902 is coupled to the at least one processor 906, and the at least one receiver 904 is coupled to the at least one processor 906.

Although in this figure, elements such as the transmitter 902, the receiver 904, and the processor 906 are illustrated in the singular, the plural is contemplated unless a limitation to the singular is explicitly stated. In some embodiments of the present application, the transmitter 902 and the receiver 904 may be combined to one device, such as a transceiver. In some embodiments of the present application, the apparatus 900 may further include an input device, a memory, and/or other components. The transmitter 902, the receiver 904, and the processor 906 may be configured to perform any of the methods described herein (e.g., the method described with respect to any of FIGS. 4-8).

According to some embodiments of the present application, the apparatus 900 may be a first UE. In some embodiments of the present application, the processor 906 is configured to perform an SL positioning procedure with a second UE, and the transmitter 902 is configured to transmit an abort message to abort the SL positioning procedure to the second UE. The processor 906 is further configured to abort the SL positioning procedure in response to transmitting the abort message.

In some embodiments of the present application, the second UE helps the first UE to acquire its position, and the processor 906 is further configured to: in the case that an SL positioning method and at least one of an RAT-dependent positioning method or RAT-independent positioning method are available for the first UE, determine to use the SL positioning method based on at least one of an accuracy requirement or a latency requirement of a target service; in the case that only the SL positioning method is available for the first UE, determine to use the SL positioning method in response to at least one of the followings: SL PRS information for the first UE satisfies the accuracy requirement of the target service; or a number of anchor UEs discovered by the first UE is larger than or equal to a minimum number of anchor UEs for the accuracy requirement of the target service; and initiate the SL positioning procedure with the second UE in response to determining to use the SL positioning method.

In some embodiments of the present application, the second UE helps the first UE to acquire its position, and the receiver 904 is configured to receive positioning assistance data which includes SL PRS information, and the processor 906 is further configured to initiate the SL positioning procedure with the second UE in response to receiving the positioning assistance data.

In some embodiments of the present application, the abort message includes an identification associated with the SL positioning procedure.

In some embodiments of the present application, the abort message is an RRC message, and the identification is a layer-2 ID associated with the SL positioning procedure.

In some embodiments of the present application, the abort message is an upper layer message.

In some embodiments of the present application, the receiver 904 is configured to receive an abort message including the identification associated with the SL positioning procedure from a network.

In some embodiments of the present application, the second UE helps the first UE to acquire its position, and the transmitter 902 is configured to transmit the abort message to the second UE in response to at least one of the following conditions: a target service is cancelled by the first UE; the first UE receives an abort message associated with the SL positioning procedure from an LMF; an SL positioning method cannot guarantee an accuracy requirement of a target service of the first UE; or the first UE decides to abort the SL positioning procedure by the first UE's implementation.

In some embodiments of the present application, the SL positioning method cannot guarantee the accuracy requirement of the target service of the first UE when at least one of the following conditions occurs: a new positioning method different from the SL positioning method is available for the first UE and the first UE determines to change to use the new positioning method; a number of available anchor UEs for the first UE is lower than a minimum number of anchor UEs for the accuracy requirement of the target service; or new PRS information different from current PRS information is acquired by the first UE.

In some embodiments of the present application, the first UE helps the second UE to acquire its position, and the transmitter 902 is configured to transmit the abort message to the second UE in response to at least one of the following conditions: a positioning capability of the first UE to support the SL positioning procedure changes; the first UE receives an abort message associated with the SL positioning procedure from an LMF; or the first UE decides to abort the SL positioning procedure by the first UE's implementation.

In some embodiments of the present application, the second UE helps the first UE to acquire its position, and the receiver 904 is configured to receive new PRS information different from current PRS information in or along with an abort message associated with the SL positioning procedure from a network. The new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, the receiver 904 is configured to receive positioning assistance data, and the new PRS information and the abort message associated with the SL positioning procedure are included in the positioning assistance data.

In some embodiments of the present application, the first UE helps the second UE to acquire its position, and the receiver 904 is configured to receive new PRS information different from current PRS information in or along with an abort message associated with the SL positioning procedure from a network. The new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from current SL PRS configuration. The transmitter 902 is configured to transmit the received new PRS information in or along with the abort message that is transmitted to the second UE.

In some embodiments of the present application, the second UE helps the first UE to acquire its position, and the transmitter 902 is further configured to transmit a PRS information request to a network to acquire new PRS information different from current PRS information before transmitting the abort message. The receiver 904 is configured to receive the new PRS information before the transmitter transmits the abort message, wherein the new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, the first UE helps the second UE to acquire its position, and the transmitter 902 is further configured to transmit an indication to a network to indicate that the SL positioning procedure will be aborted before transmitting the abort message.

In some embodiments of the present application, the receiver 904 is configured to receive new PRS information different from current PRS information from the network, and the transmitter 902 is configured to transmit the received new PRS information in or along with the abort message to the second UE The new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, to abort the SL positioning procedure, the processor 906 is configured to abort at least one of: a positioning capability transfer procedure between the first UE and the second UE; an SL PRS configuration procedure between the first UE and the second UE; an SL PRS transmission procedure between the first UE and the second UE; or a measurement reporting procedure between the first UE and the second UE.

According to some embodiments of the present application, the apparatus 900 may be a second UE. In some embodiments of the present application, the processor 906 is configured to perform an SL positioning procedure with a first UE, and the receiver 904 is configured to receive an abort message to abort the SL positioning procedure from the first UE. The processor 906 is further configured to abort the SL positioning procedure in response to receiving the abort message.

In some embodiments of the present application, to abort the SL positioning procedure, the processor 906 is configured to abort at least one of: a positioning capability transfer procedure between the first UE and the second UE; an SL PRS configuration procedure between the first UE and the second UE; an SL PRS transmission procedure between the first UE and the second UE; or a measurement reporting procedure between the first UE and the second UE.

In some embodiments of the present application, the first UE helps the second UE to acquire its position, and the processor 906 is further configured to: in the case that an SL positioning method and at least one of an RAT-dependent positioning method or RAT-independent positioning method are available for the second UE, determine to use the SL positioning method based on at least one of an accuracy requirement or a latency requirement of a target service; in the case that only the SL positioning method is available for the second UE, determine to use the SL positioning method in response to at least one of the followings: SL PRS information for the second UE satisfies the accuracy requirement of the target service; or a number of anchor UEs discovered by the second UE is larger than or equal to a minimum number of anchor UEs for the accuracy requirement of the target service; and initiate the SL positioning procedure with the first UE in response to determining to use the SL positioning method.

In some embodiments of the present application, the first UE helps the second UE to acquire its position, the receiver 904 is configured to receive positioning assistance data which includes SL PRS information, and the processor 906 is further configured to initiate the SL positioning procedure with the first UE in response to receiving the positioning assistance data.

In some embodiments of the present application, the abort message includes an identification associated with the SL positioning procedure.

In some embodiments of the present application, the abort message is an RRC message, and the identification is a layer-2 ID associated with the SL positioning procedure.

In some embodiments of the present application, the abort message is an upper layer message.

In some embodiments of the present application, the first UE helps the second UE to acquire its position, and the receiver 904 is further configured to receive new PRS information different from current PRS information from a network. The new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, the first UE helps the second UE to acquire its position, and the receiver 904 is further configured to receive new PRS information different from current PRS information in or along with the abort message from the first UE. The new PRS information includes at least one of: new anchor UE information different from current anchor UE information or an indication to trigger an SL anchor UE selection or reselection procedure; a PRS configuration or SRS configuration related to RAT-dependent positioning; or a new SL PRS configuration related to SL positioning different from a current SL PRS configuration.

In some embodiments of the present application, the apparatus 900 may further include at least one non-transitory computer-readable medium. In some embodiments of the present disclosure, the non-transitory computer-readable medium may have stored thereon computer-executable instructions to cause the processor 906 to implement any of the methods as described above. For example, the computer-executable instructions, when executed, may cause the processor 906 to interact with the transmitter 902 and/or the receiver 904, so as to perform operations of the methods, e.g., as described with respect to FIGS. 4-8.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SL positioning, including a processor and a memory. Computer programmable instructions for implementing a method for SL positioning are stored in the memory, and the processor is configured to perform the computer programmable instructions to implement the method for SL positioning. The method for SL positioning may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL positioning according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

What is claimed is:

1. A first user equipment (UE) for wireless communication, comprising:
at least one memory; and
at least one processor coupled with the at least one memory and configured to cause the first UE to:
perform a sidelink (SL) positioning procedure with a second UE;
transmit, to the second UE, an abort message to abort the SL positioning procedure; and
abort the SL positioning procedure in response to transmitting the abort message.

2. The first UE of claim 1, wherein the at least one processor is further configured to cause the first UE to:
in a case that a SL positioning method and at least one of a radio access technology (RAT)-dependent positioning method or a RAT-independent positioning method are available for the first UE, determine to use the SL positioning method based on at least one of an accuracy requirement or a latency requirement of a target service;
in a case that only the SL positioning method is available for the first UE, determine to use the SL positioning method in response to at least one of:
SL positioning reference signal (PRS) information for the first UE satisfies the accuracy requirement of the target service; or
a number of anchor UEs discovered by the first UE is larger than or equal to a minimum number of anchor UEs for the accuracy requirement of the target service; and
initiate the SL positioning procedure with the second UE in response to determining to use the SL positioning method.

3. (canceled)

4. The first UE of claim 1, wherein the abort message comprises an identification (ID) associated with the SL positioning procedure.

5. The first UE of claim 1, wherein the at least one processor is further configured to cause the first UE to transmit the abort message to the second UE in response to at least one of:
a target service is cancelled by the first UE;
the first UE receives an abort message associated with the SL positioning procedure from a location management function (LMF);
a SL positioning method cannot guarantee an accuracy requirement of a target service of the first UE; or
the first UE decides to abort the SL positioning procedure by an implementation of the first UE.

6. (canceled)

7. The first UE of claim 1, wherein the at least one processor is configured to cause the first UE to transmit the abort message to the second UE in response to at least one of:
a positioning capability of the first UE to support the SL positioning procedure changes;
the first UE receives an abort message associated with the SL positioning procedure from an LMF; or
the first UE decides to abort the SL positioning procedure by an implementation of the first UE.

8. (canceled)

9. (canceled)

10. (canceled)

11. A second user equipment (UE) for wireless communication, comprising:
at least one memory; and
at least one processor coupled with the at least one memory and configured to cause the second UE to:
perform a sidelink (SL) positioning procedure with a first UE;
receive, from the first UE, an abort message to abort the SL positioning procedure; and
abort the SL positioning procedure in response to receiving the abort message.

12. The second UE of claim 11, wherein- to abort the SL positioning procedure, the at least one processor is configured to cause the second UE to abort at least one of:
a positioning capability transfer procedure between the first UE and the second UE;
a SL positioning reference signaling (PRS) configuration procedure between the first UE and the second UE;
a SL PRS transmission procedure between the first UE and the second UE; or
a measurement reporting procedure between the first UE and the second UE.

13. (canceled)

14. (canceled)

15. (canceled)

16. The first UE of claim 4, wherein the abort message comprises a radio resource control (RRC) message, and the identification comprises a layer-2 ID associated with the SL positioning procedure.

17. The first UE of claim 1, wherein the abort message comprises an upper layer message.

18. The second UE of claim 11, wherein the abort message comprises a radio resource control (RRC) message including an identification (ID) associated with the SL positioning procedure, and the identification comprises a layer-2 ID associated with the SL positioning procedure.

19. The second UE of claim 11, wherein the abort message comprises an upper layer message.

20. A first processor for wireless communication, comprising:
at least one controller coupled with at least one memory and configured to cause the first processor to:
perform, via a first user equipment (UE), a sidelink (SL) positioning procedure with a second UE;
transmit, to the second UE, an abort message to abort the SL positioning procedure; and
abort the SL positioning procedure in response to transmitting the abort message.

21. The first processor of claim 20, wherein the abort message includes an identification (ID) associated with the SL positioning procedure.

22. The first processor of claim 21, wherein the abort message comprises a radio resource control (RRC) message, and the identification comprises a layer-2 ID associated with the SL positioning procedure.

23. The first processor of claim 20, wherein the abort message comprises an upper layer message.

24. The first processor of claim 20, wherein the at least one controller is further configured to cause the first processor to transmit the abort message to the second UE in response to at least one of:
a target service is cancelled by the first UE;
the first UE receives an abort message associated with the SL positioning procedure from a location management function (LMF);
a SL positioning method cannot guarantee an accuracy requirement of a target service of the first UE; or
the first UE decides to abort the SL positioning procedure by an implementation of the first UE.

25. The first processor of claim 20, wherein the at least one controller is further configured to cause the first processor to transmit the abort message to the second UE in response to at least one of:
a positioning capability of the first UE to support the SL positioning procedure changes;
the first UE receives an abort message associated with the SL positioning procedure from an LMF; or
the first UE decides to abort the SL positioning procedure by an implementation of the first UE.

26. A second processor for wireless communication, comprising:
at least one controller coupled with at least one memory and configured to cause the second processor to:
perform a sidelink (SL) positioning procedure with a first UE;
receive, from the first UE, an abort message to abort the SL positioning procedure; and
abort the SL positioning procedure in response to receiving the abort message.

27. The second processor of claim 26, wherein the abort message comprises a radio resource control (RRC) message including an identification (ID) associated with the SL positioning procedure, and the identification comprises a layer-2 ID associated with the SL positioning procedure.

28. The second processor of claim 26, wherein the abort message comprises an upper layer message.
